(19) United States
(12) Patent Application Publication
(10) Pub. No.: US 2025/0087012 A1
(43) Pub. Date: Mar. 13, 2025

(54) INFORMATION PROCESSING DEVICE, RECORDING MEDIUM, AND INFORMATION PROCESSING METHOD

(71) Applicant: DAI NIPPON PRINTING CO., LTD., Tokyo (JP)

(72) Inventors: Katsuhiko MINOURA, Tokyo (JP); Motoki HORITA, Tokyo (JP); Yuuki ABE, Tokyo (JP); Chigusa HOTTA, Tokyo (JP)

(73) Assignee: DAI NIPPON PRINTING CO., LTD., Tokyo (JP)

(21) Appl. No.: 18/606,521

(22) Filed: Mar. 15, 2024

(30) Foreign Application Priority Data
Sep. 13, 2023 (JP) 2023-148696

(51) Int. Cl. G06V 30/418; G06F 40/194; G06V 30/413

(52) U.S. Cl. CPC G06V 30/418; G06F 40/194; G06V 30/413

(57) ABSTRACT

An information processing device includes a control unit. The control unit acquires a plurality of examination target documents, specifies an examination item as a comparison target from the plurality of acquired examination target documents, specifies examination conditions corresponding to an examination target area of the specified examination item based on examination target information, in which an examination target area is set for each examination item of the examination target documents, and examination condition information, in which examination conditions for the examination target documents are set so as to correspond to the examination target area, examines the plurality of examination target documents based on first examination conditions for a preliminary examination, examines the plurality of examination target documents based on second examination conditions for a main examination when the examination according to the first examination conditions is normal, and outputs an examination result.

### REFERENCE TO RELATED APPLICATIONS

This application claims priority from Japanese Patent Application No. 2023-14 8696 filed on Sep. 13, 2023. The entire content of the priority application is incorporated herein by reference.

### BACKGROUND ART

The operations of financial institutions or the procedures of administrative agencies involve examining the contents of various types of documents.

Japanese Patent Laid-Open Publication No. 2017-146842 discloses a system that converts various documents such as contracts, demand documents, and communication slips into electronic data to shorten the time required for administrative processing.

However, in order to examine the documents, it may be necessary to compare the contents of one document with the contents of a plurality of other documents as well as comparing the contents of one document with the contents of the other document in a one-to-one relationship. For this reason, there has been a desire to improve the efficiency of administrative processes that involve examining a large amount of documents.

### SUMMARY

The present disclosure has been made in view of the above circumstances, and it is an object of the present disclosure to provide an information processing device, a recording medium, and an information processing method that can improve the efficiency of document examination work.

This application includes a plurality of means for solving the above problems. To give one example, an information processing device includes a control unit. The control unit acquires a plurality of examination target documents, specifies an examination item as a comparison target from the plurality of acquired examination target documents, specifies examination conditions corresponding to an examination target area of the specified examination item based on examination target information, in which an examination target area is set for each examination item of the examination target documents, and examination condition information, in which examination conditions for the examination target documents are set so as to correspond to the examination target area, examines the plurality of examination target documents, and outputs an examination result.

According to the present disclosure, it is possible to improve the efficiency of document examination work.

### BRIEF DESCRIPTION OF DRAWINGS

FIG. 1 is a diagram showing an example of the configuration of an information processing system according to the present embodiment;

FIG. 2 is a diagram showing an example of comparison targets of a plurality of examination target documents;

FIG. 3 is a diagram showing an example of an examination target area on a form;

FIG. 4 is a diagram showing an example of item names to be compared when comparing forms;

FIG. 5 is a diagram showing an example of a method for setting OCR setting information for an examination target document;

FIG. 6 is a diagram showing an example of OCR setting information;

FIG. 7 is a diagram showing an example of the processing option of recognized characters;

FIG. 8 is a diagram showing an example of the option of erroneous recognition control;

FIG. 9 is a diagram showing an example of examination rule setting information;

FIG. 10 is a diagram showing an example of the contents of entry check;

FIG. 11 is a diagram showing an example of the contents of personal information DB comparison;

FIG. 12 is a diagram showing an example of the contents of date-related check;

FIG. 13 is a diagram showing an example of the contents of comparison rules;

FIG. 14 is a diagram showing an example of the contents of the check of a digit, the presence or absence of a corporation, and a seal;

FIG. 15 is a diagram showing an example of the contents of the check of OCR results;

FIG. 16 is a diagram showing a first example of the contents of comparison with other forms;

FIG. 17 is a diagram showing a second example of the contents of comparison with other forms;

FIG. 18 is a diagram showing an example of examination results obtained by examination processing of the information processing device;

FIG. 19 is a diagram showing a display example of examination results obtained by examination processing of the information processing device;

FIG. 20 is a diagram showing an example of the processing procedure of the information processing device; and

FIGS. 21A and 21B are diagrams showing an example of an OCR rule setting screen.

### DESCRIPTION

Hereinafter, an embodiment of the present disclosure will be described with reference to the diagrams.

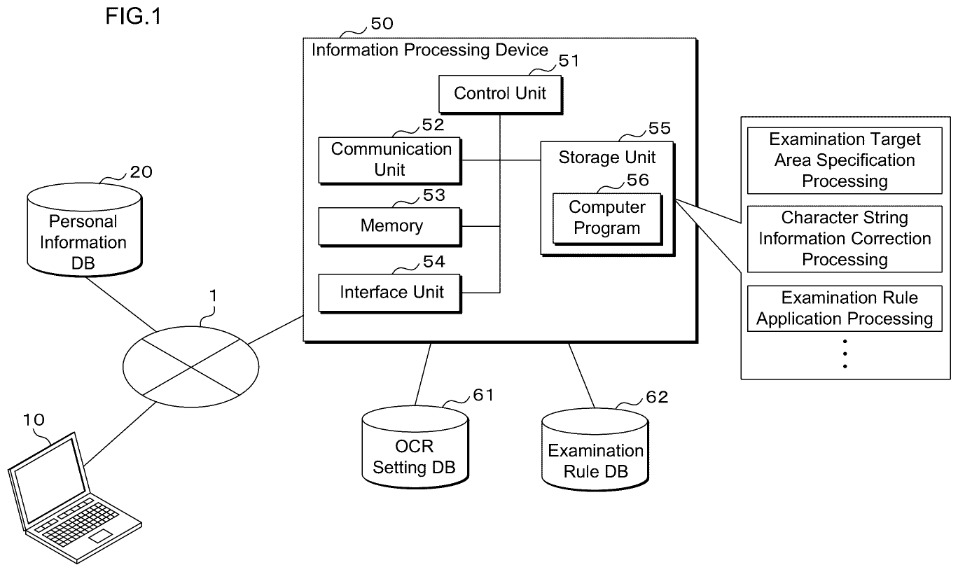

FIG. 1 is a diagram showing an example of the configuration of an information processing system according to the present embodiment. The information processing system includes an information processing device 50 and a terminal device 10 connected to the information processing device 50 through a communication network 1. In addition, the information processing device 50 can access a personal information DB (database) 20 through the communication network 1. The personal information DB 20 is, for example, a DB through which a financial institution or administrative agency manages personal information, and is managed and operated by the financial institution or administrative agency. The personal information DB 20 records, for example, contract documents to be examined and various information accompanying the contracts (for example, estimates, confirmation documents, and the like), but is not limited thereto. The personal information DB 20 may be a data server. The information processing device 50 can access an OCR setting DB 61 and an examination rule DB 62. The terminal device 10 can be, for example, a personal computer, a tablet terminal, and a smartphone, and is used by a user in charge of examining documents. In this specification, the user is a person in charge of examination.

The information processing device 50 includes a control unit 51 that controls the entire device, a communication unit 52, a memory 53, an interface unit 54, and a storage unit 55. The storage unit 55 can be, for example, a hard disk or a semiconductor memory, and stores a computer program 56 (program product) and required information. The computer program 56 may be downloaded from an external device through the communication unit 52 and stored in the storage unit 55. In addition, the computer program 56 recorded in a recording medium (for example, an optically readable disk storage medium such as a CD-ROM) may be read by a recording medium reader and stored in the storage unit 55. The information processing device 50 may be configured to share its functions among a plurality of information processing devices.

The control unit 51 includes a required number of CPUs (Central Processing Units), MPUs (Micro-Processing Units), GPUs (Graphics Processing Units), and the like. The control unit 51 can perform processing determined by the computer program 56. That is, the processing by the control unit 51 is also processing by the computer program 56. The computer program 56 can execute processes such as examination target area specification processing, character string information correction processing, and examination rule application processing.

The computer program 56 can be loaded so as to run on a single computer or on a plurality of computers interconnected through a communication network.

The communication unit 52 includes a communication module, and can transmit and receive required information to and from the terminal device 10 through the communication network 1.

The memory 53 can be a semiconductor memory, such as an SRAM (Static Random Access Memory), a DRAM (Dynamic Random Access Memory), or a flash memory. The computer program 56 is loaded into the memory 53, so that the control unit 51 can execute the computer program 56.

The interface unit 54 realizes an interface function between the OCR setting DB 61 and the examination rule DB 62.

The information processing device 50 acquires a plurality of examination target documents from the terminal device 10 through the communication unit 52. The plurality of examination target documents are classified for each examination case, and a plurality of documents to be examined are grouped together in one examination case. In the operations of financial institutions, the examination target documents include, for example, contracts for general loans, foreign loans, foreign guarantees, basic agreements, and payment approvals, and other various documents. The information processing device 50 performs predetermined processing on the acquired examination target documents and outputs examination results. The information processing device 50 may output the examination results to the terminal device 10 or to the personal information DB 20. The personal information DB 20 stores the examination results output from the information processing device 50 as data.

In the operations of financial institutions or the procedures of administrative agencies, when examining documents, it is necessary to compare the contents of one document with the contents of a plurality of other documents. For example, there are two types of examination target documents: electronic documents (text data) that can be submitted on a computer and handwritten documents. Handwritten documents are available at the counter of each financial institution, and are to be filled out by hand and submitted by the applicant. In addition, handwritten documents also include documents that are sent by mail from each financial institution and are filled out by hand and submitted by the applicant. Handwritten documents are treated as data converted into text through OCR processing. Hereinafter, comparison targets in document examination will be described. In addition, an examination target document will be described as a form.

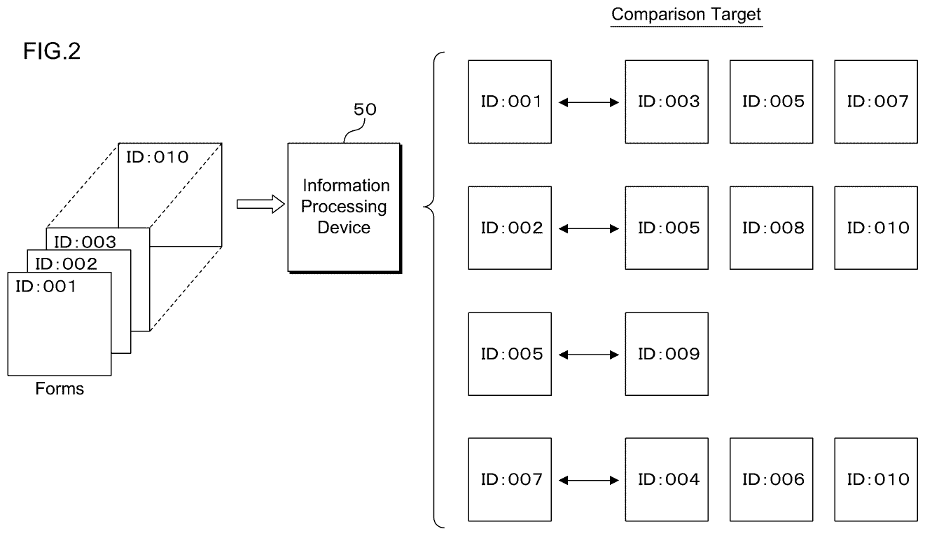

FIG. 2 is a diagram showing an example of comparison targets of a plurality of examination target documents. As an example, ten types of forms (ID: 001, 002, 003, . . . , 010) are used as a plurality of examination target documents. The information processing device 50 performs examination processing by comparing comparison target forms based on the acquired forms (specifically, electronic data obtained by reading the form with a scanner or the like). That is, one examination target document is checked by being linked to a plurality of examination target documents as related documents. In the example shown in FIG. 2, the form (ID: 001) and the three forms (ID: 003, 005, 007) are compared with each other, the form (ID: 002) and the three forms (ID: 005, 008, 010) are compared with each other, the form (ID: 005) and the form (ID: 009) are compared with each other, and the form (ID: 007) and the three forms (ID: 004, 006, 010) are compared with each other. For example, if the form (ID: 001) is a contract (XXXX contract), the three forms (ID: 003, 005, 007) correspond to a power of attorney, a seal certificate, and a confirmation letter. In addition, the example shown in FIG. 2 is just an example, and schematically shows the need to perform an examination by comparing one form with a plurality of other forms.

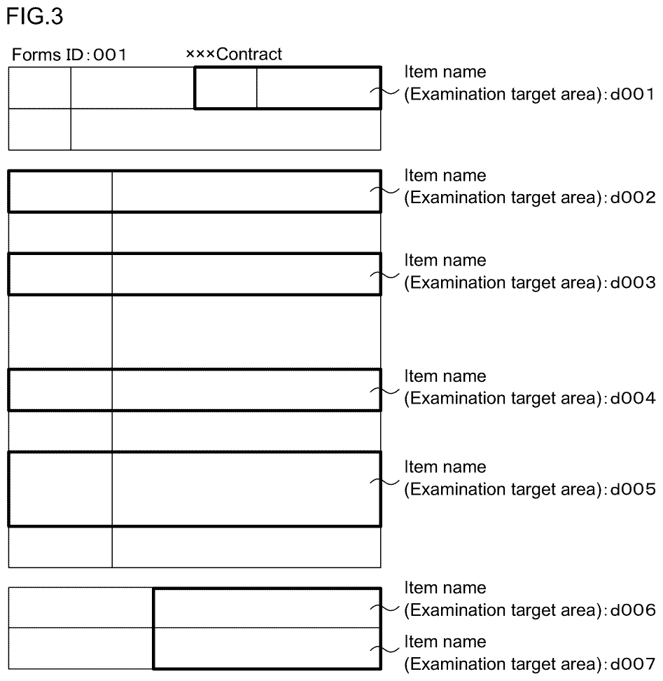

FIG. 3 is a diagram showing an example of the examination target area of a form. The examination target area specifies an area to be examined in the form (ID: 001), and an item name (examination item name) can be defined for each examination target area. The examination target area is set as, for example, a rectangular frame, and can be specified by the upper left position (coordinates) of the frame and the vertical and horizontal dimensions of the frame. In the example shown in FIG. 3, there are seven examination target areas identified by item names d001, d002, d003, d004, d005, d006, and d007. The examination target area can be specified for each form. That is, if the forms are different, the examination target areas are different.

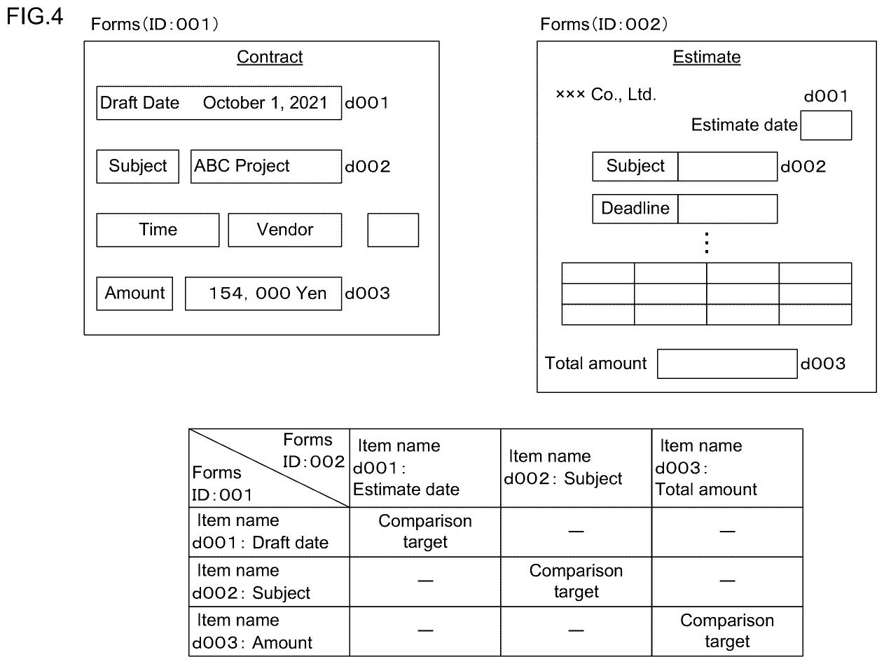

FIG. 4 is a diagram showing an example of item names to be compared when comparing forms. As shown in FIG. 4, the form (ID: 001) as a comparison target is assumed to be a contract, and the form (ID: 002) is assumed to be an estimate. It is assumed that the form (ID: 001) has items d001 (item name: draft date), d002 (item name: subject), and d003 (item name: amount), which are examination target areas, and the form (ID: 002) has items d001 (item name: estimate date), d002 (item name: draft date), and d003 (item name: total amount), which are examination target areas. In addition to the items described above, for example, information such as name, address, and telephone number is described in the examination target area. For example, the date description location differs depending on the form. That is, even if the same contents are described, the layout differs depending on the form. Therefore, as shown in FIG. 4, it is necessary to set which item name in one form should be compared with which item name in the other form. In the example shown in FIG. 4, it is specified that the item name d001 in the form (ID: 001) and the item name d001 in the form (ID: 002) are comparison targets. Similarly, it is specified that the item name d002 in the form (ID: 001) and the item name d002 in the form (ID: 002) are comparison targets, and it is specified that the item name d003 in the form (ID: 001) and the item name d003 in the form (ID: 002) are comparison targets. If the form (ID: 001) is to be compared with other forms, information similar to that shown in FIG. 4 is specified for the other forms as well. That is, the control unit 51 can set the examination target area of the examination items with the same contents so as to correspond to each examination target document as a comparison target.

When uploading a form to be examined from the terminal device 10 to the information processing device 50, the paper form is optically read with a scanner or the like and converted into electronic data (image data) through OCR processing (character recognition). Generally, in OCR processing, there is a possibility that an error of about several percent may occur in recognized characters. Therefore, in the present embodiment, OCR setting information (also referred to as examination target information) is recorded in the OCR setting DB 61, so that the control unit 51 can perform required processing on the character string within the examination target area based on the OCR setting information.

Next, a method of setting OCR setting information for each item name (examination target area) in each form will be described.

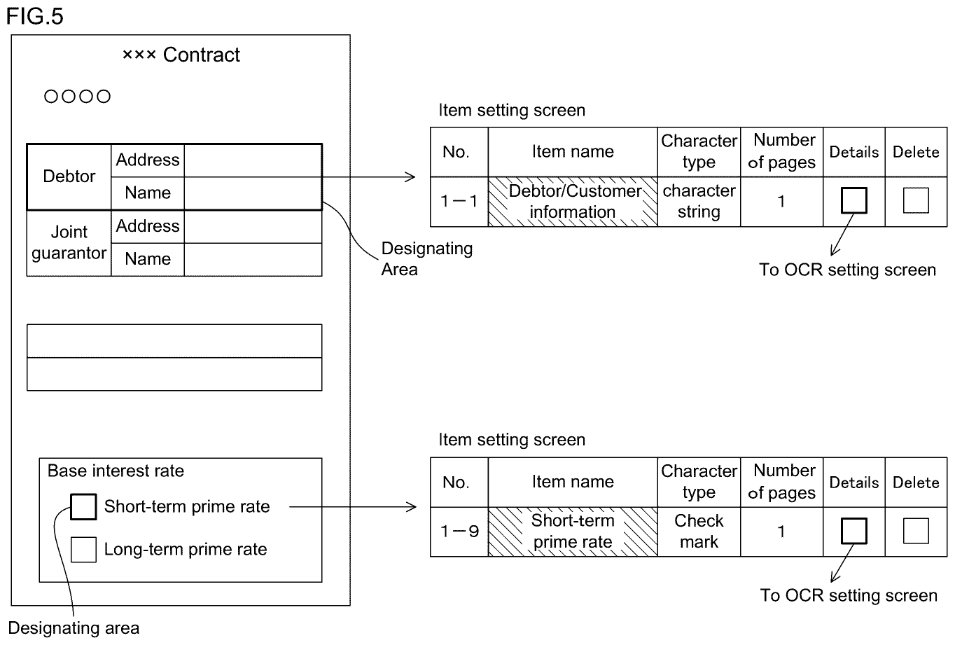

FIG. 5 is a diagram showing an example of a method of setting OCR setting information for an examination target document. In FIG. 5, “XXXX contract” will be described as an example of an examination target document (form), but the examination target document is not limited to a contract. As shown in FIG. 5, it is assumed that the XXXX contract includes, for example, the debtor's address and name, the joint guarantor's address and name, and the selection of the base interest rate (item name (examination target area) such as “short-term prime rate” and “long-term prime rate”). When the user performs an operation to designate an area (for example, an examination target area) within the examination target document, an item setting screen is displayed. For example, when the user performs an operation on an area where the debtor's address and name are described (for example, an operation of designating an area or surrounding an area), an item setting screen for the area is displayed. In the example shown in FIG. 5, the item name “debtor/customer information” is input. Similarly, when the user designates a box (area) for selecting the “short-term prime rate” of the base interest rate, the item name of the designated area can be set. In the example shown in FIG. 5, the item name “short-term prime rate” is input.

When the user operates a details box on the item setting screen, the screen transitions to the OCR setting screen where only the necessary functions among all the OCR functions can be selected and set for the item name corresponding to the operated details box. For example, when the details box with the item name “debtor/customer information” is operated, an OCR setting screen with the item name “debtor/customer information” is displayed. In addition, when a “delete” button is selected, the set item setting screen is deleted.

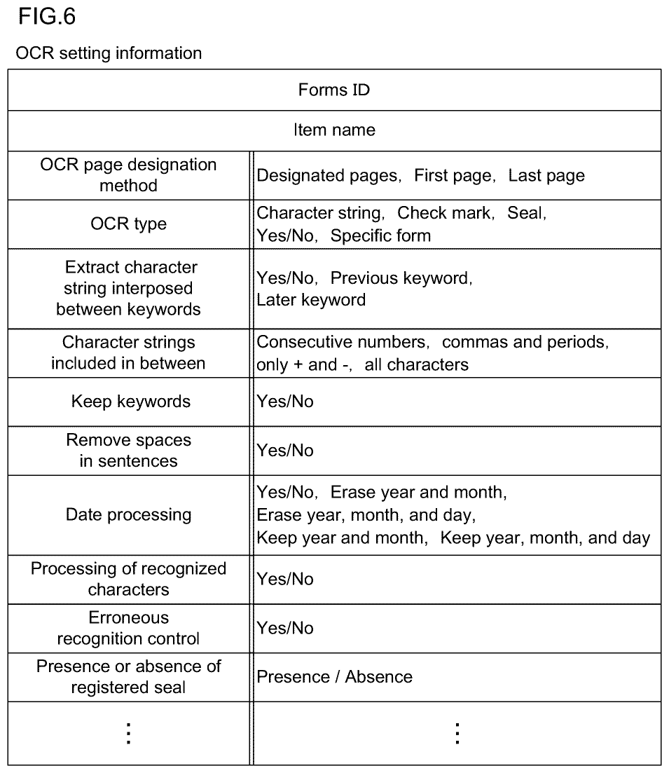

FIG. 6 is a diagram showing an example of OCR setting information. The OCR setting information is information for setting a function selected from all the OCR functions displayed on the OCR setting screen, and can be set for each item name (examination target area) in each form. The OCR setting information can be set by the user using the terminal device 10. The OCR setting information includes setting items such as OCR page designation method, OCR type, extract character string interposed between keywords, character strings included in between, keep keywords, remove spaces in sentences, date processing, processing of recognized characters, erroneous recognition control, presence or absence of registered seal.

In the OCR page designation method, a page in which character strings are to be read using OCR is designated. For example, designated pages (for example, from what page to what page) that are designated by the user, the first page, and the last page can be designated.

In the OCR type, the type of OCR can be selected. For example, at least one of character string, check mark, seal, Yes/No, specific form, and the like can be selected. All of these may be selected.

In “extract character string interposed between keywords”, a character string interposed between a previous keyword and a later keyword that are designated in advance is extracted. For example, for “extract character string interposed between keywords”, Yes/No, previous keyword, later keyword, and the like can be designated.

In character strings included in between, the type of character string included in between is selected. For example, consecutive numbers, commas and periods, only + and −, all characters, and the like can be selected.

In “keep keywords”, a character string is extracted while keeping keywords. For example, whether or not to keep keywords can be selected.

In “remove spaces in sentences”, spaces in sentences are removed. For example, “Nippon Taro” is corrected to “NipponTaro”. Whether or not to remove spaces in sentences can be selected. In addition, the above-described “extract character strings between keywords”, “character strings included in between”, “keep keywords”, and “remove spaces in sentences” are items that are set as an option set for character recognition.

In the date processing, date processing can be selected. For example, for the date processing, Yes/No, erase the year and month (for example, change “April 2022” to “202204”), erase the year, month, and day, keep the year and month, and keep the year, month, and day can be selected.

In the processing of recognized characters, the processing of recognized characters can be selected.

As described above, the OCR setting information includes correction information for correcting the character string within the examination target area. The correction information includes, for example, removal of spaces in sentences, date processing, processing of recognized characters, erroneous recognition control, and the like. The control unit 51 can correct the character string in the examination target area based on the correction information and examine a plurality of examination target documents using the corrected character string.

With the above configuration, it is possible to designate examination target areas between forms to be compared with each other. Therefore, it is possible to compare each examination target area with the correct comparison target. Compared with a case where only character strings are extracted and compared, it is possible to prevent omissions in comparison of valid comparison targets and improve the accuracy of examination results.

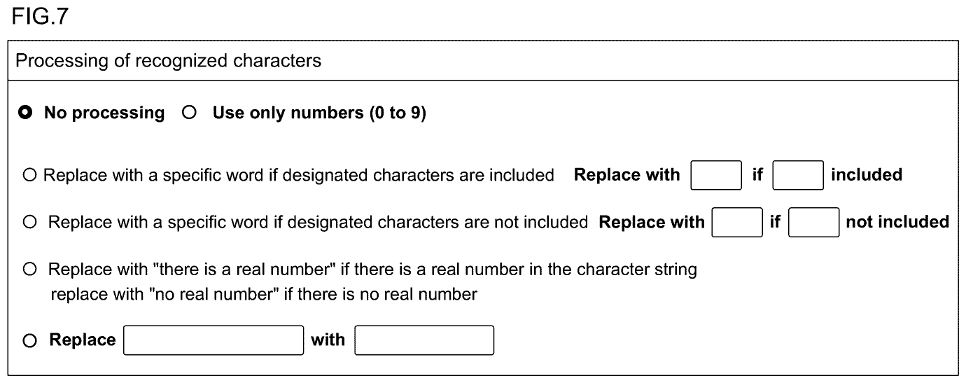

FIG. 7 is a diagram showing an example of options for processing recognized characters. The processing of recognized characters is an OCR setting condition, and processed data can be registered in the OCR setting DB 61. In the processing of recognized characters, processing or correction is performed for easy data comparison or adaptation at the time of comparison with comparison target documents. As shown in FIG. 7, for the processing of recognized characters, for example, processing or no processing, use only numbers (0 to 9) or not, replace with a specific word if designated characters are included, replace with a specific word if designated characters are not included, replace with “there is a real number” if there is a real number in the character string, replace with “no real number” if there is no real number, and replace a character string (for example, replace “Co., Ltd.” with “Company Limited”) can be selected.

In the erroneous recognition control, means for controlling erroneous recognition can be selected.

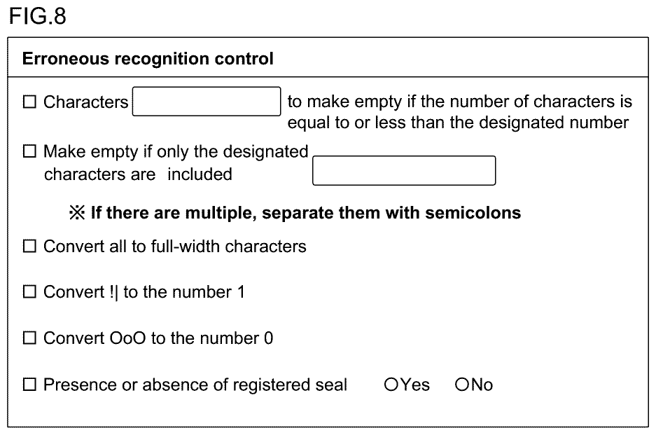

FIG. 8 is a diagram showing an example of options for erroneous recognition control. The erroneous recognition control is processing for easy comparison or adaptation of writing errors or difficult-to-read information (characters and the like) in forms (including handwritten forms) at the time of comparison with comparison target documents. As shown in FIG. 8, for the erroneous recognition control, for example, make empty if the number of characters is equal to or less than the designated number, make empty if only the designated characters are included, convert all to full-width characters, convert!| to the number 111 (convert “!!! ” to “111”), and convert OoO to the number 000 can be selected.

In the presence or absence of registered seal, whether or not there is a registered seal can be selected, and Yes/No can be selected.

In addition, in the present embodiment, examination rule setting information (also referred to as examination condition information) is set in the examination rule DB 62, so that the control unit 51 can perform examination processing on character strings within the examination target area by applying the examination rule setting information.

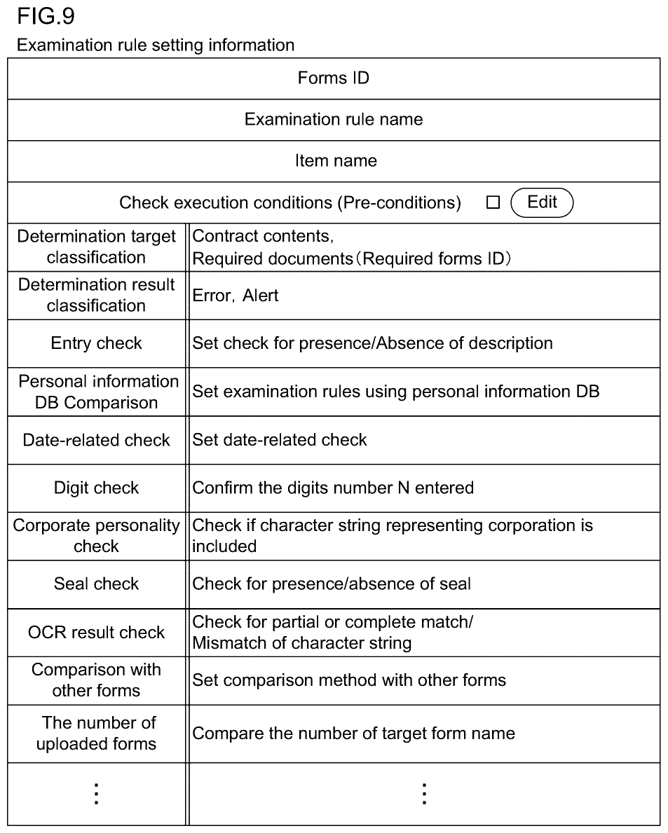

FIG. 9 is a diagram showing an example of examination rule setting information. The examination rule setting information can be set for each item name (examination target area) in each form. In addition, an examination rule name corresponding to the item name can be set. The examination rule setting information can be set by the user using the terminal device 10. In the examination rule setting information, examination rules for the examination target document read by OCR or acquired as electronic data are set. There are two types of methods for setting examination rules: setting of pre-conditions and setting of post-conditions. The examination rule setting information includes setting items such as check execution conditions, determination target classification, determination result classification, entry check, personal information DB comparison, date-related check, digit check, corporate personality check, seal check, OCR result check, comparison with other forms, and the number of uploaded forms.

As described above, the examination rule setting information includes check information including at least one of date information, number-of-digits information, corporate personality information, and seal information that are associated with the examination item. The control unit 51 can examine a plurality of examination target documents based on the check information. In this manner, it is possible to check whether or not there are any errors in the check information.

The check execution conditions have a box for setting pre-conditions. When the box is selected, the pre-conditions are set, and when the box is not selected, the post-conditions are set. The edit button is a button for transitioning to an edit screen for editing the contents of the set pre-conditions or post-conditions. On the edit screen, setting items such as determination target classification, determination result classification, entry check, personal information DB comparison, date-related check, digit check, corporate personality check, seal check, OCR result check, comparison with other forms, and the number of uploaded forms can be set. Although FIG. 9 shows only one box and edit button for setting pre-conditions, a plurality of (for example, 10) boxes and edit buttons are displayed in reality so that a plurality of pre-conditions can be set.

In the examination target document, an examination (preliminary examination) according to the pre-conditions as first examination conditions for the preliminary examination and an examination (main examination) according to the post-conditions as second examination conditions for the main examination are performed. If there are no problems with all of the examination items of the pre-conditions, an examination according to the post-conditions is performed.

The pre-conditions are conditions for examination performed before the examination according to the post-conditions is performed. While the post-conditions are a comparison of specific numerical values and written contents, the pre-conditions are a simple check related to the examination of the post-process. The contents to be examined as pre-conditions are, for example, (1) when checking age restrictions, check whether the age on the application document is 20 years or older, (2) when checking the description of specific characters or comparing information with the personal information DB, check the corporate name, check whether the corporate name registered in the personal information DB is written, and (3) if a joint guarantor is set as a contract condition, there are three prerequisites of (i) a loan contract is concluded, (ii) “the value of XX is OO”, and (iii) “the amount is 10 million yen or more”.

If the pre-conditions are satisfied, the main examination is performed by applying the examination rules of the post-conditions. Examples of the post-conditions include determination target classification, determination result classification, entry check, personal information DB comparison, date-related check, digit check, legal personality check, seal check, OCR result check, comparison with other forms, and the number of uploaded forms. For example, the post-conditions are checking the applicant's name (for example, checking whether or not the joint guarantor's name matches the name on the other examination target document to be compared) and checking the amount of the application (for example, checking whether or not the application details match the estimated amount on the other examination target document to be compared), but are not limited to these.

As shown in FIG. 9, for the determination target classification, an examination target document can be selected. For example, when examining the contract contents, “contract contents” are selected, and when checking required documents, “required documents” are selected. In addition, a form that needs to be bundled with the relevant form can be designated by using “required form ID”. In this manner, it is possible to designate all forms to be compared 1 to N (N is a number of 2 or more) without omissions.

In the determination result classification, a classification at the time of determination of the examination is selected. For example, the classification can be divided into “error” and “alert”. “Error” can be output when the examination result is NG, and “alert” can be output when the examination result cannot be said to be NG but a warning is required.

As described above, the examination rule setting information includes classification information (“error”, “alert”) for classifying examination results. The control unit 51 can output classification information. Therefore, it is possible to stratify the importance of deficiencies in examination target documents.

In the entry check, check for presence/absence of description can be set.

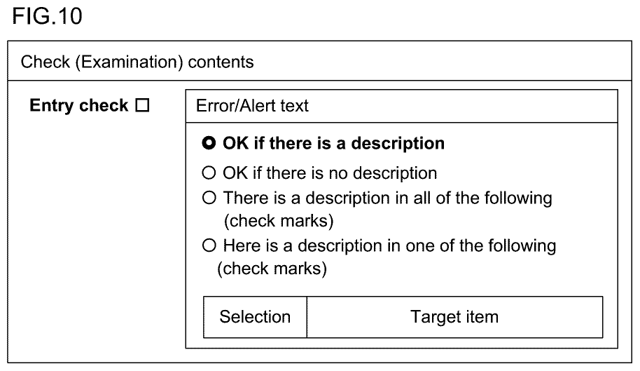

FIG. 10 is a diagram showing an example of the contents of the entry check. In the entry check, for example, there is entry check and there is no entry check, “OK if there is a description”, “OK if there is no description”, “there is a description in all of the following (check marks)”, and “there is a description in one of the following (check marks)” can be selected. In addition, if there is a “check mark” item in “OCR type”, a check box is displayed in the selection field, and the target item name is displayed in the target item field. In addition, if there is an entry check, error/alert text that is displayed when the target does not match the examination rules selected in the entry check can be set in advance.

In the personal information DB comparison, examination rules using values linked from the personal information DB are set.

As described above, the examination rule setting information includes description information (for example, entry check) in which the presence or absence of a predetermined description within the examination target area is set. The control unit 51 can examine a plurality of examination target documents based on the description information.

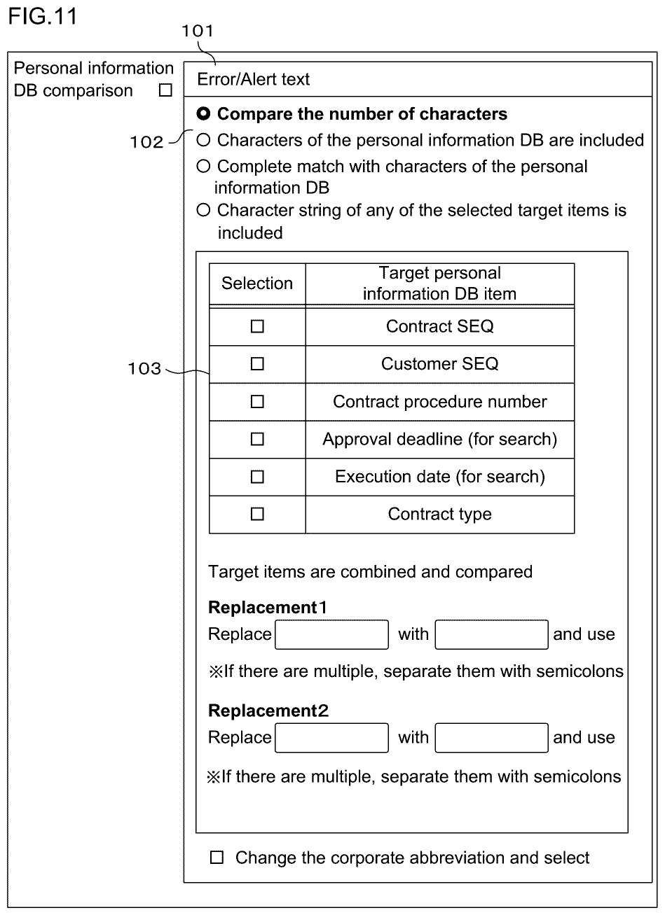

FIG. 11 is a diagram showing an example of the contents of personal information DB comparison. In an error/alert text field 101, error/alert text that is displayed when the target does not match the examination rules selected in the personal information DB comparison can be set in advance. In a comparison setting field 102, “compare the number of characters”, “characters of the personal information DB are included”, “complete match with characters of the personal information DB”, and “character string of any of the selected target items is included” can be selected. In a target personal information DB item field, the name of the item to be compared is displayed, and in a selection field, a check box 103 is displayed. As item names in the target personal information DB item field, for example, contract SEQ, customer SEQ, contract procedure number, product deadline, execution date, and contract type can be included. For example, the contract SEQ specifies a sequence of contracts. In addition, in the target personal information DB item, a character string as a replacement source and a character string as a replacement destination can be designated. In addition, it is also possible to change the corporate abbreviation (for example, change “Co., Ltd.” to “Company Limited”) and select “compare or don't compare”.

In FIG. 11, if there is a check in “characters of the personal information DB are included”, it is checked whether or not the creditor's representative name described in the examination target document is registered in (that matches) the personal information DB 20 (DPOST). If the creditor's representative name is not registered in the personal information DB 20, an alert set in the error/alert text field 101 is output.

As described above, the examination rule setting information includes third selection information in which one or more personal information items are selected in association with the examination item. The third selection information includes information linked from the personal information DB, and corresponds to, for example, contract information and contract-related information (customer number, name, address, building name, contract number, and the like). The control unit 51 can examine a plurality of examination target documents based on the third selection information. In this manner, for example, even for the items related to customer information, it is possible to check whether or not there is an error.

In the date-related check, it is possible to set the date-related check contents.

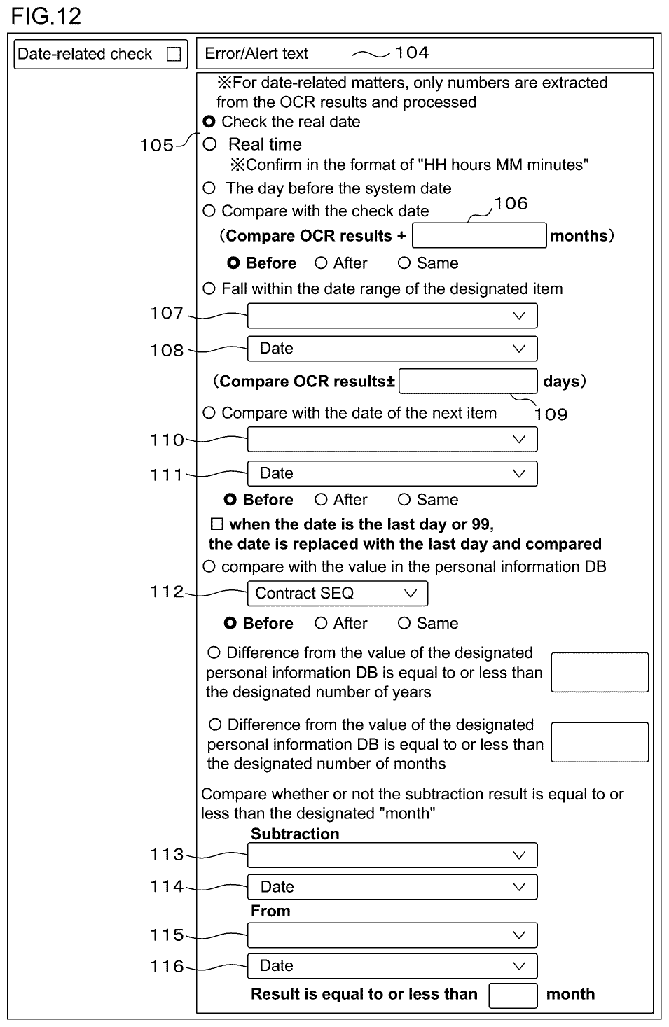

FIG. 12 is a diagram showing an example of the contents of the date-related check. In an error/alert text field 104, error/alert text that is displayed when the target does not match the examination rules selected in the date-related check can be set in advance. In a check method field 105, “check the real date”, “real time”, “the day before the system date”, “compare with the check date”, “fall within the date range of the designated item”, “compare with the date of the next item”, “compare with the value in the personal information DB”, “compare whether or not the subtraction result is equal to or less than the designated “month”, and the like are displayed in a selectable form.

When “compare with the check date” is selected, the number of months to be compared is designated in a number-of-months field 106. The comparison method can be selected from “before”, “after”, or “same”.

When “fall within the date range of the designated item” is selected, a target form to be compared is selected in a target form field 107, an OCR item of the selected target form is designated in a date field 108, and the number of days to be compared is designated in a number-of-days field 109.

When “compare with the date of the next item” is selected, a target form to be compared is selected in a target form field 110, and an OCR item of the selected target form is designated in a date field 111. As a comparison method, one of “before”, “after”, and “same” can be selected. In addition, when “when the date is the last day or 99, the date is replaced with the last day and compared” is selected, the date is replaced with the “last day” and compared if there is a description such as “99-th day of N month” or “last day of N month”.

When “compare with the value of the personal information DB” is selected, an item of the personal information DB to be compared is selected in an item field 112. As a comparison method, one of “before”, “after”, “same”, “difference from the value of the designated personal information DB is equal to or less than the designated number of years”, and “difference from the value of the designated personal information DB is equal to or less than the designated number of months” can be selected.

When “compare whether or not the subtraction result is equal to or less than the designated month” is selected, one of the target forms to be compared is selected in a target form field 113, and the OCR item of the selected target form is designated in a date field 114. In addition, another target form to be compared is selected in a target form field 115, and the OCR item of the selected target document is designated in a date field 116. It is also possible to designate the number of months to check whether or not the subtraction result is equal to or less than a predetermined number of months.

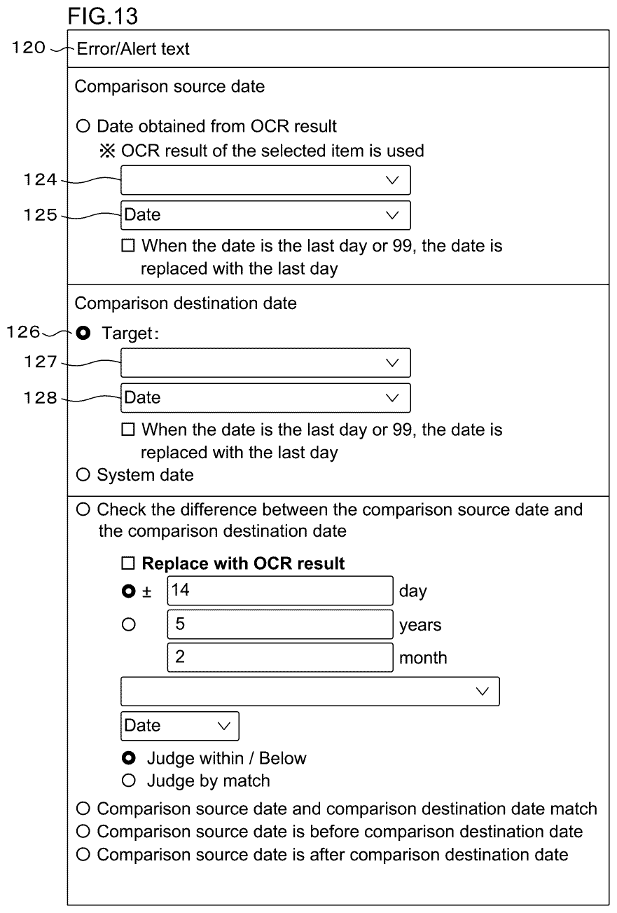

FIG. 13 is a diagram showing an example of the contents of the comparison rules. As the comparison rules, a comparison source date, a comparison destination date, and comparison conditions can be set. In an error/alert text field 120, error/alert text that is displayed when the target does not match the examination rules set in the comparison can be set in advance.

When “date obtained from OCR result” is selected, the form name of the comparison source is set in a form field 124, and the OCR item name of the comparison source date is set in a date field 125. In addition, when “when the date is the last day or 99, the date is replaced with the last day and compared” is selected, the date is replaced with the “last day” and compared if there is a description such as “99-th day of N month” or “last day of N month”.

In a comparison date field 126, “target” and “system date” can be selected. When “target” is selected, the form name of the comparison destination is set in a form field 127, and the OCR item name of the date of the comparison destination is set in a date field 128. In addition, when “when the date is the last day or 99, the date is replaced with the last day and compared” is selected, the date is replaced with the “last day” and compared if there is a description such as “99-th day of N month” or “last day of N month”.

When “check the difference between the comparison source date and the comparison destination date” is selected, it is possible to set the number of days corresponding to the date difference, the number of years corresponding to the date difference, and the number of months corresponding to the date difference.

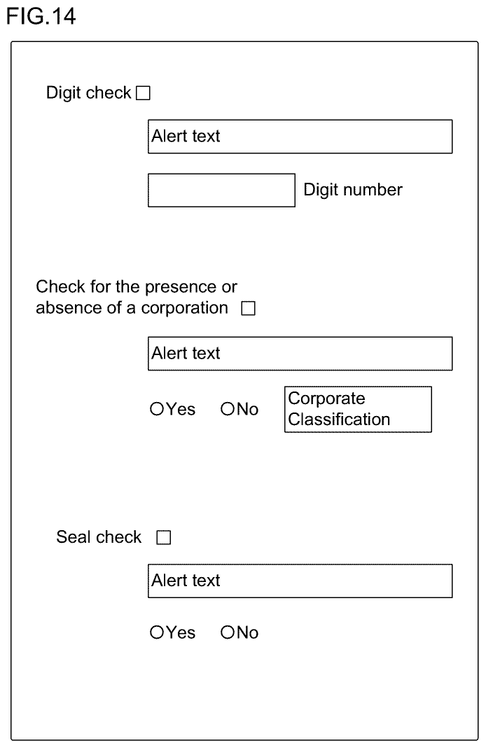

FIG. 14 is a diagram showing an example of the contents of checking the presence or absence of a corporation and checking the seal. The digit check is an examination rule for checking a match with the input number of digits N. It is possible to set in advance an error text that is output when the target does not match the number of input digits.

The check for the presence or absence of a corporation is an examination rule for checking whether or not a character string representing a corporation is included. It is possible to set in advance an error text that is output when the target does not match the character string representing the corporation. In addition, it is possible to set the corporate classification (corporate type) when checking the presence or absence of a corporation.

The seal check is an examination rule for checking the presence or absence of a seal. It is possible to set in advance an error text that is output when the target does not match the examination rules regarding the presence or absence of a seal.

For example, when seal check is selected and “no” is selected, the examination is passed if there is no seal in the designated area, and a message such as “seal found” is displayed if there is a seal in the designated area. On the other hand, when seal check is selected and “yes” is selected, the examination is passed if there is a seal in the designated area, and an error message such as “no seal” is displayed if there is no seal in the designated area.

The OCR result check is an examination rule for checking partial or complete match/mismatch of a character string. As described above, by setting the comparison source date, the comparison destination date, and the comparison conditions in advance, the user performing the examination can freely design the examination rules for ease of use.

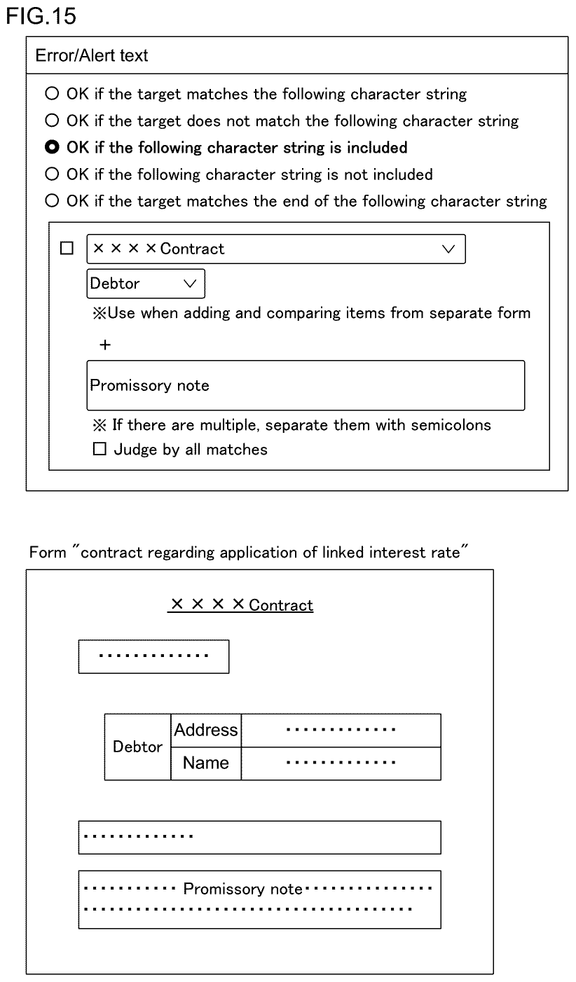

FIG. 15 is a diagram showing an example of the contents of checking the OCR result. It is possible to set a comparison method for comparing character strings for each form's item name (examination target area). For example, comparison methods such as “OK if the target matches the following character string”, “OK if the target does not match the following character string”, “OK if the following character string is included”, “OK if the following character string is not included”, and “OK if the target matches the end of the following character string” can be selected. Specifically, it is possible to check character string comparison (match or included/not included) for the selected item. In the check error text, it is possible to set the error text that is displayed when the target does not match the selected rule. It is possible to designate a character string comparison method using a radio button. It is possible to designate a form and an item and input a characteristic string to compare using the selected method.

In the comparison with other forms, a method for comparison with other forms can be set as an examination rule.

For example, as shown in FIG. 15, assuming that “OK if the following character string is included” is selected and characters “XXXX contract”, “debtor”, and “promissory note” are set for the form “contract regarding application of linked interest rate”, if the three characters “XXXX contract”, “debtor”, and “promissory note” are extracted from the form “contract regarding application of linked interest rate” acquired by OCR, a message such as “there are check items on the promissory note” is displayed. By outputting such a message, it is possible to alert the user and accordingly, it is possible to prevent omissions in the examination.

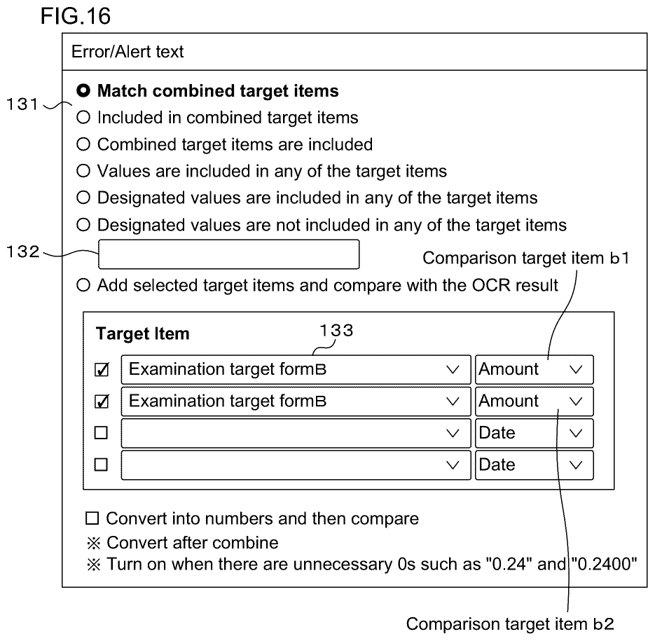

FIG. 16 is a diagram showing a first example of contents of comparison with other forms. In the first example, it is possible to set a comparison method when comparing items of other forms bundled with the item name of a form as a target. In a comparison setting field 131, comparison methods such as “match combined target items”, “included in combined target items”, “combined target items are included”, “values are included in any of the target items”, “designated values are included in any of the target items”, and “designated values are not included in any of the target items” can be selected. “Combine” means combining all selected items. In a numerical value field 132, designated values can be set.

In addition, when “add selected target items and compare with the OCR result” is selected, a form can be selected in a target item field 133. In the example shown in FIG. 16, as target items, (1) “amount” is set as an examination target form B and a comparison target item b1, and (2) “amount” is set as the examination target form B and a comparison target item b2. When “convert into numbers and then compare” is selected, character strings can be converted into numbers. For example, “0.24” and “0.2400” are different character strings. However, both “0.24” and “0.2400” become “0.24” by converting “0.24” and “0.2400” into numbers. Therefore, these can be compared with the OCR result. It is possible to set in advance an error message that is output when the target does not match the examination rules regarding the contents of comparison with other forms.

Specifically, it is assumed that “match combined target items” is selected. It is assumed that A is an examination target form and B is another examination target form to be compared. It is assumed that the examination target form A is “XXXX application form” and the amount of the examination target form A is “20 million yen”. It is assumed that the examination target form B to be compared is “XXXX estimate”, the “amount” of the comparison target item b1 is “2000”, and the “amount” of the comparison target item b2 is “10000 yen”. Since the result of combining the “amount” of the examination target form B is “20 million yen”, the amount of the examination target form A matches the amount of the examination target form B.

In this manner, by combining the comparison target item of another form B to be compared with the examination target form A, comparison with the examination target form A, which is a check source, becomes possible.

As described above, the examination rule setting information includes first selection information in which one or more examination target documents (forms) are selected in association with examination items. The first selection information can be information including items of other forms bundled with the item name of a form as a target. The control unit 51 can examine a plurality of examination target documents based on the first selection information. Therefore, even when the contents of one document should be compared with the contents of a plurality of other documents, the target documents (forms) can be easily associated.

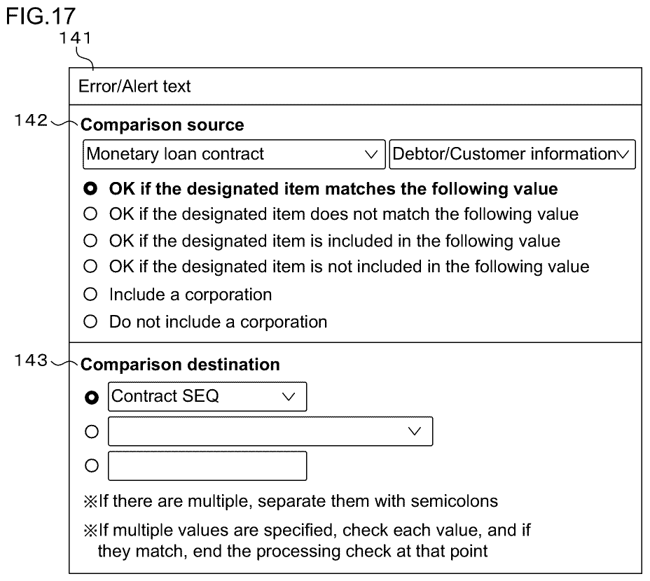

FIG. 17 is a diagram showing a second example of contents of comparison with other forms. In the second example, instead of comparing the items of other forms bundled with the item name of a form as a target as in the first example, it is possible to set a comparison method when comparing the items of the bundled forms. In an error/alert text field 141, error/alert text that is displayed when the target does not match the examination rules set in the contents of comparison with other forms can be set in advance.

In a comparison source field 142, the form name of the comparison source can be selected, and a comparison method at the time of comparison can be selected. In the example shown in FIG. 17, the form name of the comparison source is “monetary loan contract” and the examination item is “debtor/customer information”. As comparison methods, “OK if the designated item matches the following value”, “OK if the designated item does not match the following value”, “OK if the designated item is included in the following value”, “OK if the designated item is not included in the following value”, “include a corporation”, and “do not include a corporation” can be selected.

In a comparison destination field 143, a method for comparison with a comparison source form can be selected. For example, items of the personal information DB, items of other forms, and specific character strings can be selected. In the example shown in FIG. 17, the form name of the comparison destination is “contract SEQ”.

For example, as shown in FIG. 17, when “OK if the designated item matches the following value” is selected, it is examined whether or not the debtor information of the monetary loan contract matches the information of the contract SEQ recorded in the personal information DB 20. When the debtor information of the monetary loan contract does not match the information of the contract SEQ recorded in the personal information DB 20, a message set in the error/alert text field 141 is displayed.

As described above, the examination rule setting information includes second selection information in which a comparison source document and a comparison destination document are selected from a plurality of examination target documents. The second selection information can be information including items between the bundled forms. The control unit 51 can examine a plurality of examination target documents based on the second selection information. Therefore, even when the contents of one document should be compared with the contents of a plurality of other documents, the target documents (forms) can be easily associated.

In the number of uploaded forms, the number of target form names is compared. For example, in order to compare the number of target form names, the file name designated when attaching a form can be designated in the personal information DB. Therefore, it is possible to determine whether or not the target form has been uploaded in just the right amount.

As described above, the control unit 51 acquires a plurality of examination target documents, and specifies examination items as comparison targets from the plurality of acquired examination target documents (forms). In the specification of examination items, the examination target area set in advance for each form may be specified, and the position of the specified examination target area and the item name may be recorded in association with each other. The control unit 51 specifies examination conditions corresponding to the examination target area of the specified examination item based on OCR setting information (examination target information), in which the examination target area is set for each examination item of the examination target document, and the examination rule setting information (examination condition information), in which examination conditions for the examination target document are set so as to correspond to the examination target area (examination item), examines a plurality of examination target documents based on the first examination conditions for the preliminary examination, and examines a plurality of examination target documents based on the second examination conditions for the main examination when the examination according to the first examination conditions is normal. The examination conditions include, for example, setting items such as determination target classification, determination result classification, entry check, personal information DB comparison, date-related check, digit check, legal personality check, seal check, OCR result check, comparison with other forms, and the number of uploaded forms for each item name of the examination rule setting information illustrated in FIG. 9. The control unit 51 outputs the examination result.

With the configuration described above, it is possible to simply check inconsistencies with the contents of the approval process, errors in customer information or document contents, the presence or absence of required documents, whether or not all documents to be submitted are prepared, whether incorrect document formats are used, and the like. For example, the entire process from contract creation to confirmation to conclusion can be digitized to improve operational efficiency. In addition, even when the contents of one document should be compared with the contents of a plurality of other documents regarding a large number of documents, it is possible to improve the efficiency of document examination work.

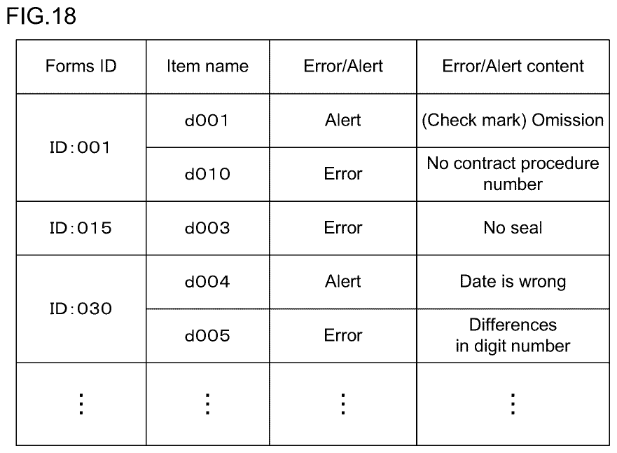

FIG. 18 is a diagram showing an example of examination results obtained by the examination processing of the information processing device 50. The examination results shown in FIG. 18 can be viewed on the display panel of the terminal device 10. In addition, the terminal device 10 can also download the examination results from the information processing device 50. As shown in FIG. 18, as the examination results, the item name, error/alert classification, and error/alert content are displayed for each form ID. In the example shown in FIG. 18, regarding form ID: 001, there is a document deficiency in item d001. Therefore, an alert is output, and the contents of the alert are (check mark) that there is an omission, and an error is output for item d010, and the contents of the error are that there is no contract procedure number. In addition, regarding form ID: 015, an error is output for item d003, and the contents of the error are that there is no seal. Similarly, regarding form ID: 030, an alert is output for item d004, the contents of the alert are that the date is wrong, an error is output for item d005, and the contents of the error are differences in the number of digits. The same applies to other forms.

In the example shown in FIG. 18, only the names of items with alerts or errors are displayed for convenience. However, for example, a list of items of all examination target forms may be displayed so that the presence or absence of an alert and the presence or absence of an error can be checked (item names for which there are neither alerts nor errors may also be displayed). In addition, an image of each form may be displayed, and the item name for which there is an alert or error may be highlighted and displayed (displayed in a different display mode). In addition, the example shown in FIG. 18 is just an example, and the method of displaying the examination results is not limited to the example shown in FIG. 18.

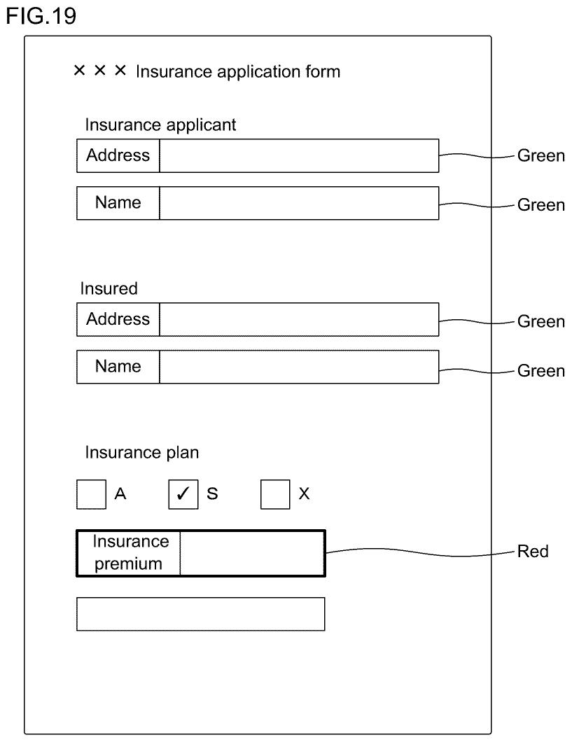

FIG. 19 is a diagram showing a display example of the examination results obtained by the examination processing of the information processing device 50. An explanation will be given using an insurance application form as an example of an examination target document (form). In the insurance application form, examination items (examination target area) include, for example, the address and name of the insurance applicant, the address and name of the insured, an insurance plan, and an insurance premium. By comparing the examination target document (form) with other examination target forms, the examination results for each examination item can be displayed in different colors on the original examination target document (form). For example, in the example shown in FIG. 19, the address and name of the insurance applicant, the address and name of the insured, and the insurance plan have passed the examination. Therefore, for example, the frame indicating the examination target area is displayed in green. On the other hand, since the insurance premium does not match between the examination target document (form) and other forms to be compared, the insurance premium can be displayed in a red frame indicating that the examination result is abnormal. In addition, the display is not limited to the color frame display, and display methods such as filling the target portion with a color or adding characters (O, X, check mark, and the like) may also be used. In addition, although the explanation has been given using the insurance application form as an example in FIG. 19, the present invention is not limited thereto. For example, examination results for documents defined as examination target documents, such as contracts, other application forms, and confirmation letters, are also included.

In addition, examination items that did not pass the examination are displayed and recorded as an error log. The error log includes, for example, determination results (for example, error in XXXX examination item), check target (for example, examination target document: insurance application form), examination item (for example, amount check), error message (for example, insurance premium XXXX does not match the amount on the estimate).

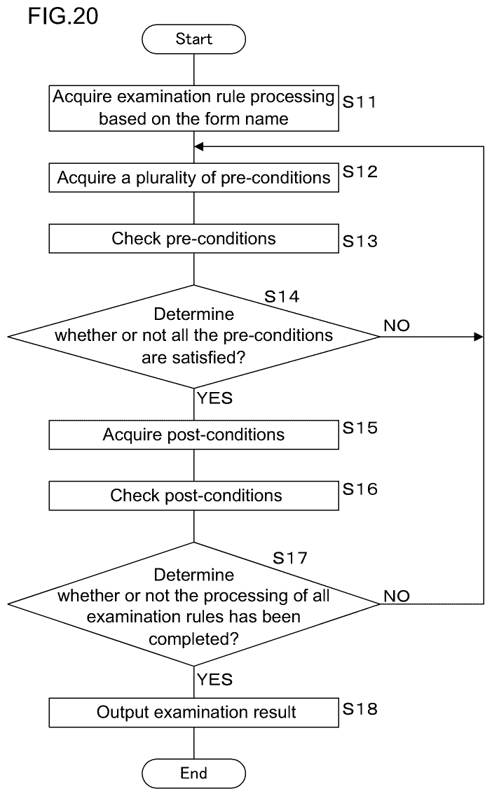

FIG. 20 is a diagram showing an example of the processing procedure of the information processing device 50. For convenience, the following explanation will be given with the control unit 51 as the main body of the processing. The control unit 51 acquires examination rule processing based on the form name (S11), and acquires a plurality of (for example, 5 cases or 10 cases) pre-conditions (S12). The control unit 51 checks the pre-conditions (S13) and determines whether or not all the pre-conditions are satisfied (S14).

If all the pre-conditions are not satisfied (NO in S14), the control unit 51 continues the processing from step S12. When all the pre-conditions are satisfied (YES in S14), the control unit 51 acquires the post-conditions (S15) and checks the post-conditions (S16). The control unit 51 determines whether or not the processing of all examination rules has been completed (S17), and if the processing has not been completed (NO in S17), the processing from step S12 is continued.

If the processing of all examination rules is completed (YES in S17), the control unit 51 outputs the examination result (S18) and ends the processing. The output of the examination results includes, for example, the output of the results (color display determination) for the examination target document illustrated in FIG. 19 or the output of error notification results (error log).

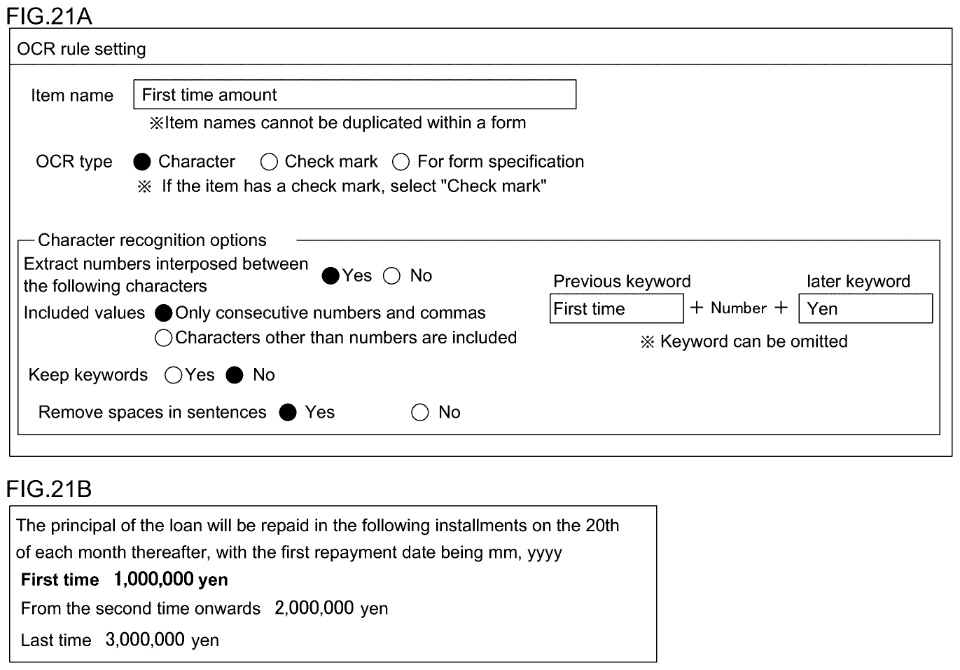

FIGS. 21A and 21B are diagrams showing an example of an OCR rule setting screen. The OCR rule setting screen shown in FIG. 21A corresponds to the OCR setting information and the like illustrated in FIG. 6. That is, it is possible to set OCR rules such as “OCR type” (character string, check mark, seal, for form specification), “extract numbers interposed between the following characters” (Yes/No, previous keyword, later keyword), “included values” (only consecutive numbers and commas and characters other than numbers are included), “keep keywords” (Yes/No), and “remove spaces in sentences” (Yes/No). In addition, as shown in FIG. 21A, “extract numbers interposed between the following characters”, “included values”, “keep keywords” and “remove spaces in sentences” are set as a set of character recognition options. In addition, the OCR rules shown in FIG. 21A are just an example, and are not limited to the example shown in FIG. 21A.

In FIG. 21A, “OCR Type” is set to “character”, “extract numbers interposed between the following characters”, is set to “Yes”, the previous keyword is set to “first time”, and the later keyword is set to “Yen”. “included values” is set to “only consecutive numbers and commas”, “keep keywords” is set to “No”, and “remove spaces in sentences” is set to “Yes”.

Then, when applying the form shown in FIG. 21B to OCR, the numbers interposed between the keywords “previous” and “yen” are extracted, and the values included at that time are only consecutive numbers and commas. Therefore, the number “1,000,000” is extracted.

In the above embodiment, the examination target documents in financial institutions have been mainly described. However, the present embodiment is not limited to the financial institutions. The present embodiment can be applied to fields in which it is necessary to perform one-to-many or many-to-many comparisons of a large number of examination target documents, for example, various fields such as administrative agencies and the publishing industry.

### (Supplementary Note 1)

An information processing device includes a control unit. The control unit acquires a plurality of examination target documents, specifies an examination item as a comparison target from the plurality of acquired examination target documents, specifies examination conditions corresponding to an examination target area of the specified examination item based on examination target information, in which an examination target area is set for each examination item of the examination target documents, and examination condition information, in which examination conditions for the examination target documents are set so as to correspond to the examination target area, examines the plurality of examination target documents based on first examination conditions for a preliminary examination, examines the plurality of examination target documents based on second examination conditions for a main examination when the examination according to the first examination conditions is normal, and outputs an examination result.

### (Supplementary Note 2)

In the information processing device according to Supplementary Note 1, the examination target information includes correction information for correcting character strings in the examination target area, and the control unit corrects the character strings in the examination target area based on the correction information and examines the plurality of examination target documents using corrected character strings.

### (Supplementary Note 3)

In the information processing device according to Supplementary Note 1 or 2, the examination condition information includes description information in which presence or absence of a predetermined description in the examination target area is set, and the control unit examines the plurality of examination target documents based on the description information.

### (Supplementary Note 4)

In the information processing device according to any one of Supplementary Notes 1 to 3, the examination condition information includes first selection information in which one or more examination target documents are selected in association with the examination item, and the control unit examines the plurality of examination target documents based on the first selection information.

### (Supplementary Note 5)

In the information processing device according to any one of Supplementary Notes 1 to 4, the examination condition information includes second selection information in which a comparison source document and a comparison destination document are selected from the plurality of examination target documents, and the control unit examines the plurality of examination target documents based on the second selection information.

### (Supplementary Note 6)

In the information processing device according to any one of Supplementary Notes 1 to 5, the examination condition information includes third selection information in which one or more personal information items are selected in association with the examination item, and the control unit examines the plurality of examination target documents based on the third selection information.

### (Supplementary Note 7)

In the information processing device according to any one of Supplementary Notes 1 to 6, the examination condition information includes check information including at least one of date information, number-of-digits information, corporate personality information, and seal information that are associated with the examination item, and the control unit examines the plurality of examination target documents based on the check information.

### (Supplementary Note 8)

In the information processing device according to any one of Supplementary Notes 1 to 7, the examination condition information includes classification information for classifying examination results, and the control unit outputs the classification information.

### (Supplementary Note 9)

In the information processing device according to any one of Supplementary Notes 1 to 8, the control unit sets examination target areas of examination items, in which the same contents are described, so as to correspond to respective examination target documents as comparison targets.

### (Supplementary Note 10)

A computer program causes a computer to execute processing for: acquiring a plurality of examination target documents; specifying an examination item as a comparison target from the plurality of acquired examination target documents; specifying examination conditions corresponding to an examination target area of the specified examination item based on examination target information, in which an examination target area is set for each examination item of the examination target documents, and examination condition information, in which examination conditions for the examination target documents are set so as to correspond to the examination target area; examining the plurality of examination target documents based on first examination conditions for a preliminary examination; examining the plurality of examination target documents based on second examination conditions for a main examination when the examination according to the first examination conditions is normal; and outputting an examination result.

### (Supplementary Note 11)

An information processing method includes: acquiring a plurality of examination target documents; specifying an examination item as a comparison target from the plurality of acquired examination target documents; specifying examination conditions corresponding to an examination target area of the specified examination item based on examination target information, in which an examination target area is set for each examination item of the examination target documents, and examination condition information, in which examination conditions for the examination target documents are set so as to correspond to the examination target area; examining the plurality of examination target documents based on first examination conditions for a preliminary examination; examining the plurality of examination target documents based on second examination conditions for a main examination when the examination according to the first examination conditions is normal; and outputting an examination result.

The matters described in each embodiment can be combined with each other. In addition, the independent claims and the dependent claims described in the claims can be combined with each other in all combinations, regardless of the citation form. In addition, although the form of multiple claims that cite two or more other claims (multi-claim form) is used in the scope of claims, the present invention is not limited thereto. A form of multi-claim (multiple claim) that cites at least one multi-claim can also be used.

It is to be noted that, as used herein and in the appended claims, the singular forms “a”, “an”, and “the” include plural referents unless the context clearly dictates otherwise.
As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-11. (canceled)

12. An information processing device, comprising:
a control unit,
wherein the control unit acquires a plurality of examination target documents,
specifies an examination item as a comparison target from the plurality of acquired examination target documents,
specifies examination conditions corresponding to an examination target area of the specified examination item based on examination target information, in which an examination target area is set for each examination item of the examination target documents, and examination condition information, in which examination conditions for the examination target documents are set so as to correspond to the examination target area,
examines the plurality of examination target documents based on first examination conditions for a preliminary examination,
examines the plurality of examination target documents based on second examination conditions for a main examination when the examination according to the first examination conditions is normal, and
outputs an examination result.

13. The information processing device according to claim 12,
wherein the examination target information includes correction information for correcting character strings in the examination target area, and
the control unit corrects the character strings in the examination target area based on the correction information, and examines the plurality of examination target documents using corrected character strings.

14. The information processing device according to claim 12,
wherein the examination condition information includes description information in which presence or absence of a predetermined description in the examination target area is set, and
the control unit examines the plurality of examination target documents based on the description information.

15. The information processing device according to claim 12,
wherein the examination condition information includes first selection information in which one or more examination target documents are selected in association with the examination item, and
the control unit examines the plurality of examination target documents based on the first selection information.

16. The information processing device according to claim 12,
wherein the examination condition information includes second selection information in which a comparison source document and a comparison destination document are selected from the plurality of examination target documents, and
the control unit examines the plurality of examination target documents based on the second selection information.

17. The information processing device according to claim 12,
wherein the examination condition information includes third selection information in which one or more personal information items are selected in association with the examination item, and
the control unit examines the plurality of examination target documents based on the third selection information.

18. The information processing device according to claim 12,
wherein the examination condition information includes check information including at least one of date information, number-of-digits information, corporate personality information, and seal information that are associated with the examination item, and
the control unit examines the plurality of examination target documents based on the check information.

19. The information processing device according to claim 12,
wherein the examination condition information includes classification information for classifying examination results, and
the control unit outputs the classification information.

20. The information processing device according to claim 12,
wherein the control unit sets examination target areas of examination items, in which the same contents are described, so as to correspond to respective examination target documents as comparison targets.

21. A computer readable non-transitory recording medium recording a computer program causing a computer to execute processing for:
acquiring a plurality of examination target documents;
specifying an examination item as a comparison target from the plurality of acquired examination target documents;
specifying examination conditions corresponding to an examination target area of the specified examination item based on examination target information, in which an examination target area is set for each examination item of the examination target documents, and examination condition information, in which examination conditions for the examination target documents are set so as to correspond to the examination target area;
examining the plurality of examination target documents based on first examination conditions for a preliminary examination;
examining the plurality of examination target documents based on second examination conditions for a main examination when the examination according to the first examination conditions is normal; and
outputting an examination result.

22. An information processing method, comprising:
acquiring a plurality of examination target documents;
specifying an examination item as a comparison target from the plurality of acquired examination target documents;
specifying examination conditions corresponding to an examination target area of the specified examination item based on examination target information, in which an examination target area is set for each examination item of the examination target documents, and examination condition information, in which examination conditions for the examination target documents are set so as to correspond to the examination target area;
examining the plurality of examination target documents based on first examination conditions for a preliminary examination;
examining the plurality of examination target documents based on second examination conditions for a main examination when the examination according to the first examination conditions is normal; and
outputting an examination result.
